(19) United States
(12) Patent Application Publication
(10) Pub. No.: US 2002/0103772 A1
(43) Pub. Date: Aug. 1, 2002

(54) System and method for gathering of real-time current flow information

(76) Inventor: Bijoy Chattopadhyay, Plano, TX (US)

Correspondence Address: BROBECK, PHLEGER & HARRISON LLP, 4801 Plaza on the Lake, Austin, TX, 78746, US

(21) Appl. No.: 09/774,497

(22) Filed: Jan. 31, 2001

(51) Int. Cl. G06F 17/60

(52) U.S. Cl. 705/412; 705/400; 705/10

(57) ABSTRACT

A system for evaluating real-time power flow information includes a collection device operable to collect measurement data associated with at least one point in a power transmission network and a server in communication with the collection device and operable to process the measurement data to determine a current at the at least one point. The system also includes a client in communication with the server and operable to display the current as being associated with the at least one point and a cost associated with the current and the at least one point.

### CROSS-REFERENCES TO RELATED APPLICATIONS

### STATEMENT REGARDING FEDERALLY SPONSORED RESEARCH OR DEVELOPMENT

### MICROFICHE APPENDIX

### BACKGROUND OF THE INVENTION

1. Technical Field Of The Invention

This invention relates in general to the field of power engineering, and more particularly to a system and method for gathering of real-time current flow information.

2. Background Of The Invention

The past several years have introduced many changes in the traditionally heavily regulated power industry. For example, the deregulation of the sales and services components of the power industry has opened up the power distribution industry to additional players and the accompanying increase in market competition. Additionally, there is a rapid growth in the volume of the trading of power and electricity. Such higher volume has resulted in the trading of power and electricity becoming a major component of the power industry business.

Businesses focusing on the power and electricity trading market have experienced major gains and major losses in positions as a result of shifts in the supply of power due to unforeseen market volatility. States have come close to suffering major power outages in recent months, with a few states implementing mandatory revolving power outages in response to the market's short supply due to scheduled or unscheduled or emergency maintenance, unforeseen weather conditions, or other causes of interruptions in supply. Like in any economic trading market, timely, accurate information is what differentiates those who can capitalize on current or pending market conditions and those who discover such conditions too late.

Few sources exist for providing information on market conditions on the transaction of power and electricity. The sources that do exist come from: future exchanges such as the NYMEX, Chicago Board of Trade, and IPE that offer price information on future price contracts; information sources such as Reuters, Bloomberg, and Platts that provide historical information on supply and demand based on seasonal demand, weather conditions, and other empirical data; and e-commerce trading sites where traders can log on and see current prices being offered by sellers. None of these sources offer real-time data to traders of power and electricity, nor do they offer any tools enabling traders to quickly process and access such information.

### SUMMARY OF THE INVENTION

In accordance with the present invention, a system and method for generation of real-time current flow information is disclosed that provides additional advantages over and/or substantially reduces disadvantages associated with previous sources of current flow information.

In one embodiment of the present invention, a system for evaluating real-time current flow information is disclosed. The system includes a collection device operable to collect measurement data associated with at least one point in a power transmission network and a server in communication with the collection device and operable to process the measurement data to determine a current at the at least one point. The system also includes a client in communication with the server and operable to display the current as being associated with the at least one point and a cost associated with the current and the at least one point.

### BRIEF DESCRIPTION OF THE DRAWINGS

The details of a preferred embodiment of the present invention, both as to its structure and operation, can best be understood in reference to the accompanying drawings, in which like reference numerals refer to like parts, and in which:

FIG. 1 is one embodiment of a system for gathering real-time data associated with the flow of transport across a network implemented according to an aspect of the present invention;

FIG. 2 is one embodiment of a computer used to implement various components of the system illustrated in FIG. 1 implemented according to an aspect of the present invention;

FIG. 3 is one embodiment of the processing server illustrated in FIG. 1 implemented according to an aspect of the present invention;

FIG. 4 is one embodiment of the format of the device entry illustrated in FIG. 3 implemented according to an aspect of the present invention;

FIG. 5 is one embodiment of a process for generating flow information implemented according to an aspect of the present invention;

FIG. 6 is one embodiment of a process for processing magnitude data implemented according to an aspect of the present invention;

FIG. 7 is one embodiment of a process executed between a client and the processing server illustrated in FIG. 1 implemented according to an aspect of the present invention;

FIG. 8 is one embodiment of a process for performing path optimization implemented according to an aspect of the present invention; and

FIG. 9 is one embodiment of a process for financial inquiry support implemented according to the teachings of the present invention.

### DETAILED DESCRIPTION OF A PREFERRED EMBODIMENT OF THE INVENTION

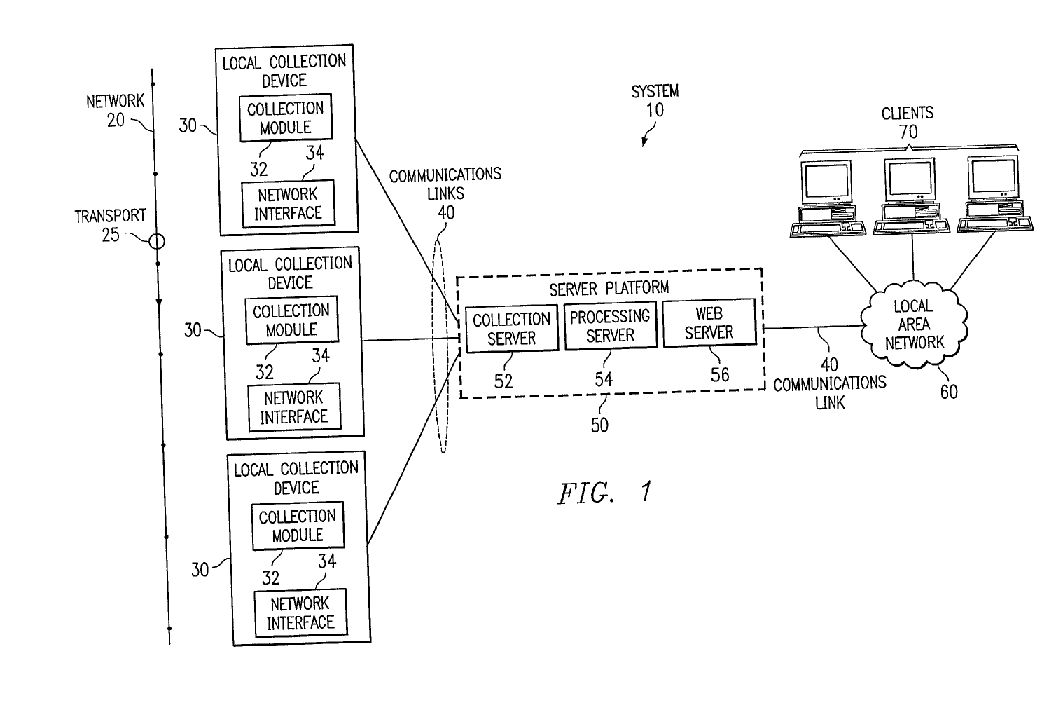

FIG. 1 illustrates one embodiment of a system 10 for collecting, processing, and presenting data associated with the flow of transport 25 along a network 20. The data collected, processed, and presented by the system 10 allows users or automated engines to make decisions regarding the utilization, allocation, and transaction of the transport 25. In the illustrated embodiment, the system 10 may be utilized to collect, process, and present data associated with current flow across power transmission lines between nodes of a power transmission network. In such an embodiment, such data may be used, for example, to allow participants in a electric commodity market to trade electricity by assisting the decision process to buy, sell or supply power.

In yet another embodiment, the system 10 may be used to collect, process and present data associated with bandwidth utilization in a data transmission network. In such an embodiment, such data may be used, for example, to allow companies to make decisions to buy, sell or allocate bandwidth.

In the illustrated embodiment, the network 20 is a power transmission network carrying electricity as the transport 25. Alternatively, other networks that carry transport for which flow information is desired may also be used with the described components of the present invention.

The system 10 includes one or more local collection devices 30 in communication with a server hardware platform 50 and one or more clients 70 using the communications links 40. In the illustrated embodiment, the clients 70 are deployed on a local area network 60.

The local collection devices 30 each include a collection module 32 and a network interface 34. In the illustrated embodiment, the collection module 32 is a non-intrusive measurement device operable to detect changes in the magnetic field surrounding power transmission lines of the network 20 at a particular node or point. One such device includes a circuit positioned such that its current flow is affected by an electromotive force induced by the magnetic field surrounding power transmission lines and a meter measuring changes caused by such electromotive force. Alternatively, the collection module 32 may be an intrusive measurement device similar to devices commercially used in the power industry such as protective relays, meters, remote terminal units, digital fault recorders, data loggers, and other suitable devices. For purposes of this specification, non-intrusive measurement devices shall be measurement devices that are not in contact with a power line while intrusive measurement devices shall be measurement devices that are in contact with a power line. The collection module 32 may include processor and memory components to enable data sampling and comparison using suitable algorithms and other embedded software, as discussed below. The collection module 32 may, alternatively, merely receive data associated with measurements at a particular node or point of the network 20 and not perform measurements directly.

In the illustrated embodiment, the network interface 34 is a wireless interface with a transmitter for transmitting data over a wireless network via one of the communications links 40 using Code Division Multiple Access (CDMA). Alternatively, the network interface 34 may use any suitable wireless or wired transmission protocols and techniques to communicate over a wireless or wired network. Thus, the network interface 34 may be any suitable network communications hardware and/or software to enable communication with the server hardware platform 50 via one of the communications links 40. The network interface 34 may also function as a receiver to enable local collection device to download software or other data to enable remote upgrades, maintenance, initialization, and the communication of other faults or commands.

The communications links 40 may be dedicated or switched links of one or more private or public networks. For example, in one embodiment the local collection devices 30 may communicate with the server hardware platform 50 via both a wireless network such as a cellular network and a Public Switched Telephone Network (PSTN). In such an embodiment, the local collection devices 30 may communicate data collected from the network 20 over an existing wireless network to take advantage of a previously deployed wireless infrastructure. For further example, the server hardware platform 50 may communicate with the clients 70 of the local area network 60 through a wide area network or a virtual private network. Each of the communications links 40 may be implemented using fiber, cable, twisted-pair, satellite, radio, microwave, or other suitable wired or wireless links.

The server hardware platform 50 includes a collection server 52, a processing server 54, and a web server 56. Although illustrated to include separate servers, the server hardware platform 50 may instead be one physical server having logical and/or physical components to fulfill the functionality of the collection server 52, the processing server 54, and the web server 56 as described herein. If the server hardware platform 50 does include separate servers, such servers may communicate with each other via local network or via one or more the communications links 40. Thus, the servers 52, 54, and 56 may be centrally located or may each be disbursed at different network nodes and/or geographically distinct facilities.

In the illustrated embodiment, the collection server 52 is a wireless gateway to the Internet or other suitable network that routes information communicated wirelessly from the local collection devices 30 to the processing server 54 over the Internet or such other suitable network. As described, the collection server 52 may be integrated with the processing server 54 in a single server or may be linked to the processing server 54 via a private or public network. The collection server 52 may also include other components operable to translate, assemble, packetize, buffer, schedule, route, encrypt, channel, and otherwise initiate the transmission of information received from the local collection devices 30 to the processing server 54. The collection server 52 also communicates information received from the processing server 54 to the local collection devices 30.

The processing server 54 includes the processing modules and databases necessary to process and archive data received from the local collection devices 30 and analyze such data to provide flow information to users of the system 10 associated with the network 20. One embodiment of the software modules performing such processing and analysis, as well as the specific database used by the processing server 54 to archive information, are further described with reference to FIG. 3.

The web server 56 provides a web-based interface to information generated by the processing server 54. The web server 56 stores web pages, JAVA servlets, and other suitable content and executables to enable users of the system 10 to easily access the features and capabilities of the processing server 54. As described, the web server 56 may be integrated with the processing server 54 in a single server or may be linked to the processing server 54 via a private or public network. In one embodiment, the web server 56 is a voice-enabled server allowing users the capability of using voice commands to access the content of the processing server 54.

In the illustrated embodiment, each of the clients 70 is a personal computer; alternatively, the clients 70 may each be a client, workstation, terminal, personal computer, web appliance, personal digital assistant, cellular telephone, pager or any other suitable computing device having input and output modules that enable a user to enter and view data. The clients 70 may each include a web browser or other interface software and/or hardware, volatile and/or non-volatile memory, a processor and/or other processing components, and/or other software, hardware, and peripherals suitable for such computing devices.

Although the server hardware platform 50 and the clients 70 are referred to in the nomenclature of a client/server environment, any suitable arrangement of computing devices may be utilized.

In the illustrated embodiment of the system 10, HyperText Transfer Protocol (HTTP) is used to communicate information between the server hardware platform 50 and the clients 70. Alternatively, techniques and protocols such as Wireless Application Protocol (WAP), Time Division Multiple Access (TDMA), Frequency Division Multiple Access (FDMA), File-Transfer Protocol (FTP), Telnet, Usenet, mobile agents, cookies, FLEX & REFLEX paging, other suitable paging, electronic mail, instant messaging, bulletin boards, or any other suitable communication techniques may be utilized to communicate data between components of the system 10 over one or more of the communications links 40.

The clients 70 may maintain and execute browsers or other suitable parsing programs for accessing and communicating information addressed by Uniform Resource Locators (URLs). Any suitable communications protocol may be implemented in combination with one or more generally available security and/or encryption techniques to ensure the secure, private communication of data between the server hardware platform 50 and the clients 70.

In the illustrated embodiment, various components of the system 10 are implemented in a programming environment that supports access or linking to various sources of information in network 10 using URL addresses. As such, the content of such modules and databases may be constructed using Hypertext Mark-Up Language (HTML), Extensible Mark-Up Language (XML), other forms of Standard Generalized Mark-Up Language (SGML), Virtual Reality Mark-Up Language (VRML), Javascript, or any other appropriate content development language. The modules of the system 10 may also include program code, such as applets or servlets written in Java, or other appropriate self-executing code.

Although the components of the server hardware platform 50 are illustrated in this FIG. 1 as separate servers, the components of all of such servers may be implemented using a single processor for the server hardware platform 50 such that the single processor accesses stored algorithms, executables, and other data that are stored in read-only memory, for example, and executed using random access memory. Likewise, any databases, modules, subsystems and other illustrated may be combined, separated or distributed across one or more processing and/or memory devices. Memory for such databases, modules, subsystems, or other components of the server hardware platform 50 may be implemented using one or more files, data structures, lists, or other arrangements of information stored in one or more components of random access memory, read-only memory, magnetic computer disks, compact disks, other magnetic or optical storage media, or any other volatile or non-volatile memory.

Likewise, it should be understood that any components of the system 10 may be internal or external to the illustrated components of the system 10, depending on the particular implementation. Also, such databases, modules, subsystems or other components may be separate or integral to components such as the local collection devices 30, the server hardware platform 50, and the clients 70. Any appropriate referencing, indexing, or addressing information can be used to relate back to an address or location of a database, file or object within the system 10.

The operation of the system 10 illustrated in FIG. 1 using the components described herein is described in the following portions of the description referring to FIGS. 3 through 8. However, in general, the system 10 illustrated in FIG. 1 receives data collected by the local collection devices 30 to determine the magnitude of the flow of the transport 25 through a node or other point on the network 20. In one embodiment, such data is magnetic field fluctuations detected by local collection device 30 and usable to derive a current. The system 10 then calibrates such data to derive the flow rate of the transport 25 and presents such flow rate data together with additional functionality for display on the clients 70 to users, such as energy traders for example, who desire access to real-time data on the flow of the transport 25 along the network 20.

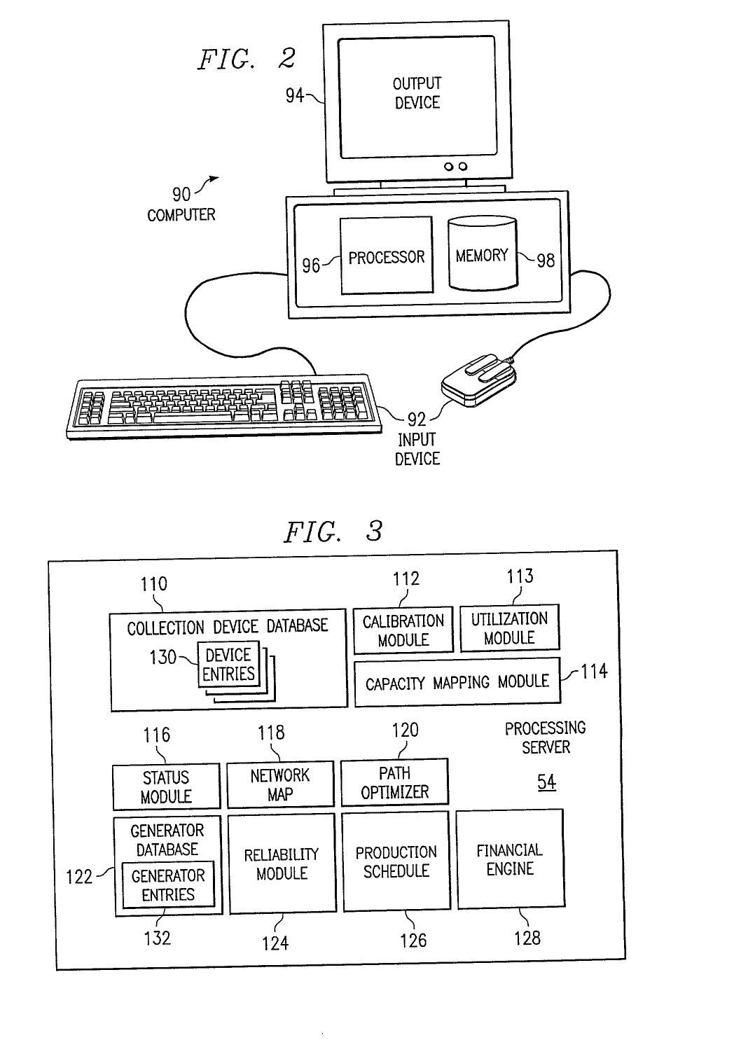

Referring to FIG. 2, in one embodiment, the servers 52, 54, and 56 and the clients 70 operate on one or more computers 90. Each computer 90 includes one or more input devices 92 such as a keypad, touch screen, mouse, microphone, or other suitable pointer or device that can accept information. An output device 94, such as a speaker, monitor or other display, for example, conveys information associated with the operation of the servers 52, 54, or 56 or the clients 70, including digital data, visual information, and/or audio information. A processor 96 and its associated memory 98 execute instructions and manipulate information in accordance with the operation of the system 10. For example, the processor 96 may execute coded instructions that are stored in memory 98. The computer 90 may also include fixed or movable storage media such as a magnetic computer disk, CD-ROM, or other suitable media to either receive output from, or provide output to, the servers 52, 54, or 56 or the clients 70.

Now referring to FIG. 3, one embodiment of the processing server 54 is illustrated. The processing server 54 includes a collection device database 110, a calibration module 112, a utilization module 113, a capacity mapping module 114, a status module 116, a network map 118, a path optimizer 120, a generator database 122, a reliability module 124, a production schedule 126, and a financial engine 128. Each of the modules described herein may be implemented using lookup tables, maps, tree structures, algorithms, and/or other suitable software using general purpose architecture of choice and existing programming skills.

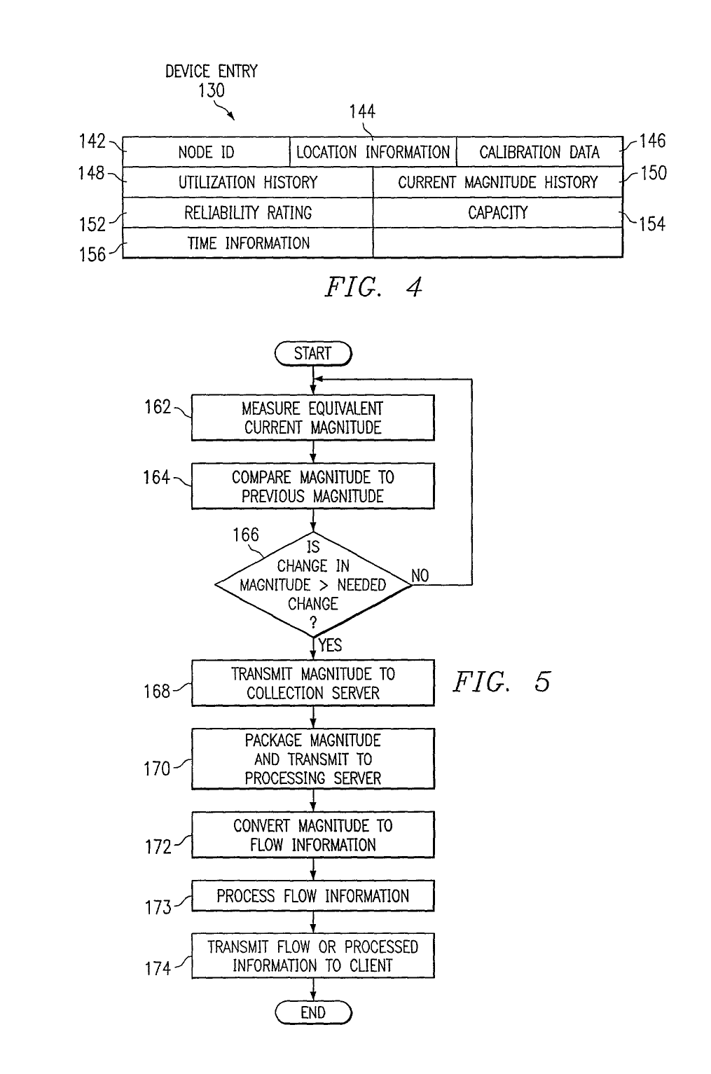

The collection device database 110 is a database stored in non-volatile memory or other suitable memory that stores information related to each node of the network 20. More particularly, the collection device database 110 includes device entries 130 that are records associated with devices taking measurements at specific nodes or other points of the network 20. Thus, each such node or other point has its own device entry 130. In some cases, nodes or points will correspond to generator entry points into the network 20. One embodiment of a device entry 130 is illustrated in FIG. 4.

The calibration module 112 is a module including calibration software that calibrates magnitude data received from one of the local collection devices 30 using calibration data from one of the device entries 130 associated with such local collection device 30 in order to determine current flow data at the network node or point where such local collection device 30 is situated.

The utilization module 113 determines the utilization percentage of the network 20 at different nodes or other points based on a known capacity of such node or point and the current flow data determined by the calibration module 112.

The capacity mapping module 114 maps the capacity and utilization of the network 20 as a whole in response to data received from the local collection devices 30, known outages, current power generation, and any other suitable information. Such information may be updated on the network map 118, which stores a map that may include all nodes and points of the network 20, including nodes, paths, connections, generators, the location of the local collection devices 30, and any other suitable locations, together with any known data on such nodes, paths, connections, generators, local collection devices, and other suitable locations, such as capacity, current utilization, transmission costs, ownership, reliability, and any other suitable data.

The status module 116 determines the status of the network 20 at each node or point in response to data received from the local collection devices 30. Such status information may then be updated in the device entries 130 and reliability ratings for each node or point determined. For example, the status module 116 may determine that a particular node is not receiving any current, is out of service, or is consistently only able to carry a small percentage of its intended capacity.

The path optimizer 120 is a software application that computes the most desirable path for energy transmission given prioritized variables such as availability, capacity, capacity utilization, transmission cost, distance, or any other suitable variables. Such variables may be weighted or discounted by a user to customize such processing.

The generator database 122 stores generator entries 132 that include information on generating capacity, real-time operating conditions, spinning reserves, scheduled maintenance, unscheduled maintenance, reliability, utilization, or any other suitable data. A separate generator entry 132 may be utilized for each power generation source.

The reliability module 124 calculates reliability ratings for generators, nodes, or other points of the network 20 based on the determinations of the capacity mapping module 114, the status module 116, the average reliability of points on the network 20, and the path in which such points lie on the network 20. The reliability module 124 may then update the device entries 130 to assign reliability ratings.

The production schedule 126 includes a schedule of power generation for all generators included within generator 122. Such schedule is archived, updated in real-time, and available for display by users of the system 10.

The financial engine 128 is a bundle of analytical tools configurable to include summaries, averages, trends and other computation on a regional or network segment basis to assist traders of the transport 25, such as energy traders, in making predictions of future power availability and transmission capacity relevant to entering into positions, options, swaps, and hedging positions. The financial engine 128 may include maps, graphs, spreadsheets, and other suitable tools as well as modeling software to allow a trader to quickly process real-time flow data associated with the network 20. In addition to utilizing the data collected and archived by the system 10, the financial engine 128 may receive and process additional information received from other sources of data relevant to market conditions in the power industry. Such additional information may be received or collected from the third party sources identified in the background of this invention or any other suitable data source. Such additional information shall be referred to as source information for purposes of describing this invention, and may include pricing information, usage information, weather information, and other types of historical or current information relevant to the transaction of electricity.

With reference to FIG. 4, one embodiment of the device entry 130 includes a node (or other network point) identification field 142, a location information field 144, a calibration data field 146, a utilization history field 148, a current magnitude field 150, a reliability rating field 152, a capacity field 154, and a time information field 156. The node identification field 142 provides a node identifier that is associated with a point in the network 20 and a particular local collection device 30. Location information field 144 may indicate a geographic location, a network grid location, a node address, or other suitable location information.

Calibration data field 146 includes information specific to the characteristics of the network 20 at the relevant node for purposes of calibrating data received from an associated local collection device 30. Calibration information may include factors such as the magnitude of the magnetic field, the orientation of power lines, the number of circuits carrying current, the distance of the power line from the ground, and the distance between the power line and local collection device 30.

The utilization history field 148 includes empirical data associated with the use of the network 20 at the associated node or point on the network 20. Current magnitude history field 150 includes empirical data associated with the flow of the transport 25 on the network 20 at the associated node or point on the network 20. The reliability rating field 152 is a numerical indicator generated by the reliability module 124 in response to the historical reliability of the associated node or point of the network 20 and is used by the system 10 to compare the reliability of different points or paths of the network 20. The capacity field 154 includes the overall capacity of the network 20 to carry current at the associated node or point. The time information field 156 includes information related to time at which measurement is taken at a particular node on the network 20.

Now referring to FIG. 5, one embodiment of a process for generating flow information is illustrated. More particularly, in step 162, one of the local collection devices 30 takes a measurement equivalent to or derived from the current currently flowing through a network node or other point. In step 164, such local collection device 30 compares the measurement with the previous measurement and an absolute value of the difference is derived. In step 166, such local collection device 30 compares the absolute value of such difference to a predetermined threshold value. Such threshold may be utilized to minimize bandwidth of the communications links 40 such that only significant differences are detected and passed along to the processing server 54 over such communications links 40. If the change does not exceed the threshold value, such local collection device 30 takes a subsequent measurement in step 162 and the process begins anew.

If the change exceeds the threshold value, the measurement of magnitude is communicated to the collection server 52 in step 168. Then, in step 170, the collection server 52 then packages, translates, assembles, packetizes, buffers, schedules, routes, encrypts, channels, and otherwise initiate the transmission of such measurement to the processing server 54. In step 172, the measurement of magnitude received by the processing server 54 is converted to current flow information by the calibration module 112 using calibration data from calibration data field 146 of the particular device entry 130 associated with collection device 30. In step 173, the current flow information is processed by the financial engine 128 as described in FIG. 3. In step 174, the current flow information is transmitted to one of the clients 70 as real-time current flow information for viewing and manipulation by a user of the system 10.

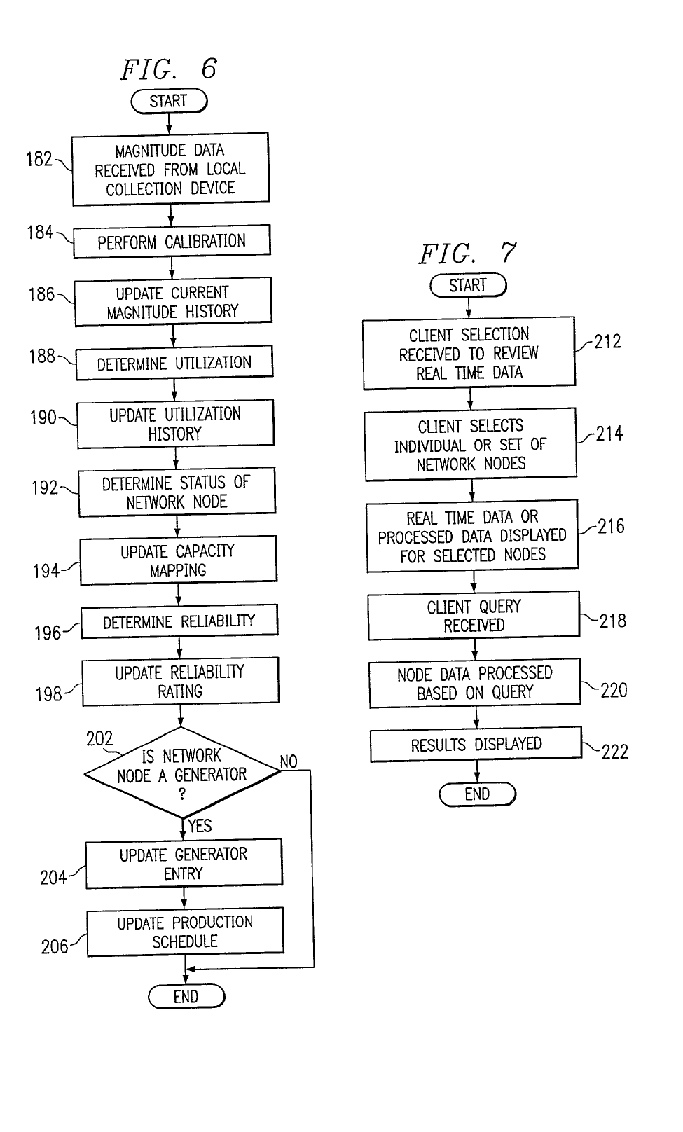

With reference to FIG. 6, one embodiment of a process for processing magnitude data received from local collection device 30 is illustrated. In particular, in step 182, magnitude data is received by the processing server 54 from one of the local collection devices 30 via the collection server 52. In step 184, such magnitude data is calibrated and current flow information is derived as described in step 172 of FIG. 5 and with reference to calibration data field 146 of FIG. 4. In step 186, current magnitude history field 150 of the associated device entry 130 is updated to reflect the calibrated current flow information. In step 188, a utilization percentage or other rating or indicator is determined in response to the derived current flow information and the capacity of the network 20 at the associated node or point that is obtained from the capacity field 154 from the associated device entry 130. In step 190, the utilization history field 148 in the associated device entry 130 is updated.

In step 192, a status determination of the associated network node or point is made in response to the derived current flow information, the capacity of the network 20 at the associated node, any known maintenance issues with power generation sources as recorded in the generator database 122, and any other suitable information. Such status determination may be a network outage at the associated node or other point, a temporary interruption in current flow due to maintenance at a generator or testing of power lines, a designation made in response to a determined utilization rating, a fully operational determination, or any other suitable determination.

In step 194, the network map 118 is updated by the capacity mapping module 114 as described in FIG. 3. In step 196, the reliability rating for the associated node or other point is determined based on the determinations of the status module 116, the average reliability of points on the network 20, and the path in which such points lie on the network 20. In step 198, the reliability rating is updated in the reliability rating field 152 of the associated device entry 130.

Next, in step 202, the processing server 54 determines if the associated network node or other point is associated with a power generation source. If the network node or other point is associated with a power generation source, the appropriate one of the generator entries 132 associated with such power generation source is updated in the generator database 122 in step 204. Also, in step 206, the production schedule 126 may be updated to reflect the new current flow data associated with the power generation source.

Now referring to FIG. 7, a process executed between one of the clients 70 and the processing server 54 via the web server 56 is illustrated. In step 212, a client selection corresponding to a desire to receive flow information of the network 20 is received from such client 70 using for example, a web page or other user interface hosted by the web server 56 or client application of such client 70.

In step 214, an additional client selection is received from such client 70 that indicates an individual node or point on the network 20 to view current flow information. Alternatively, client selection may be for a set of such nodes or points, such as transfer points, price points, generation points, points within a North American Electric Reliability Council (NERC) region, points within a specified geography, points within a particular power transmission path or group of paths, or any other suitable combination of points. Such selection may be made by such client 70 in response to a map, index, chart, or other suitable visual presentation made to the user via a web page hosted by the web server 56 or client application of such client 70.

In step 216, real-time data or processed data associated with the flow of current at each of the selected points is displayed on such client 70 after being communicated from the processing server 54 via the web server 56. In step 218, such client 70 submits a processing query associated with the displayed flow information or processed information to the processing server 54 via the web server 56. Such query may be a request to manipulate, perform calculations based on, forecast, average, graph, or otherwise process any of the flow information displayed or any other data maintained by the processing server 54. For example, a user of client 70 may wish to compare the current characteristics of current flow, cost, utilization or other parameters at a particular point on the network 20 to previous characteristics to make decisions/extrapolations/inquiries based on such real-time data. Any other suitable inquiries may be used to organize, present, and manipulate data for the user of client 70. In step 220, the processing server 54 processes the inquiry using the components illustrated in FIG. 3. In step 222, any results are displayed on such client 70.

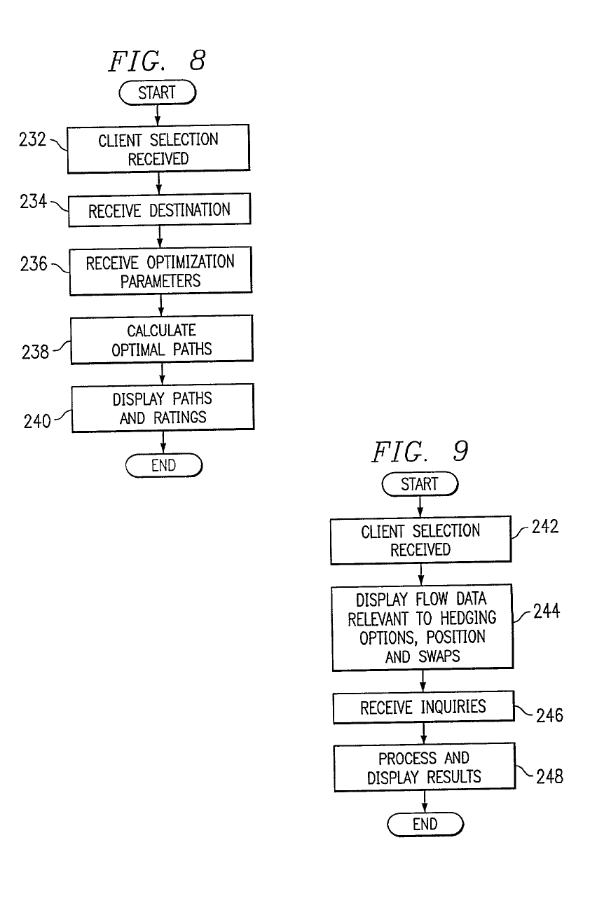

With reference to FIG. 8, a process for performing path optimization using the information maintained by the processing server 54 is illustrated. In step 232, a client selection is received by the processing server 54 from such client 70.

In step 234, the processing server 54 receives destination information from such client 70. Such destination information may, for example, correspond to a location needing electricity supplied. Such location may be a physical or geographic one or a logical location, address, node, or point on the network 20.

In step 236, optimization parameters are received from such client 70. Optimization parameters may be factors associated with cost, time, reliability, distance, capacity as they related to servicing the location and the priority the user wants such variables to be factored into determining an optimal connection path. For example, the only concern may be cost, causing the processing server 54 to ignore any of the other factors in configuring an optimal connection path. Alternatively, each of the factors may be weighted in priority to generate a sophisticated scheme for the processing server 54 to use to determine an optimal connection path.

In step 238, the processing server 54 computes an optimal connection path together with, in one embodiment, alternative paths receiving high optimization scores and communicates them to such client 70 for display in step 240. Such paths may be displayed in a path or other suitable chart, graphic, or file together with information associated with the various segments used to construct such paths. For example, each of the segments may have an associated optimization rating, reliability rating, owner, cost, utilization, real-time current flow, capacity, node identification, production schedule, or any other suitable information.

To compute an optimal connection path, the processing server 54 compares the optimization parameters set by a user with data stored by the processing server 54 that is associated with different paths or path segments for the flow of electricity. As described above, such optimization parameters may be weighted or otherwise prioritized to set an exact framework and computation for determining the optimal connection path. In such a manner, segments of paths within the network 20 may be compared to each other relative to the optimization parameters selected by the user. Thus, the processing server 54 may select path segments in response to the comparison. Based on such comparison, an optimal connection path is determined by adding the selected path segments. For example, segments A and B may be compared to each other using the optimization parameters selected by the user.

Similarly, segments C and D and segments E and F may be compared to each other. The processing server 54 may then determine that the optimal connection path between two network points includes path segments A, D and E. Such determination may change in response to changes in the optimization parameters. For example, delivery time or distance optimization parameters may be lowered in priority while the lowest cost optimization parameter is raised in priority.

With reference to FIG. 9, a process is performed that corresponds to a financial inquiry. Once the financial inquiry is selected in step 242, in step 244 the processing server 54 displays options, data sets, models, graphs, and other data and applications on such client 70 related to financial inquiries such as risk assessment and the advisability of futures, forward contracts, hedging, financial positions (short and long), options, and swaps based on the real-time information processed by the processing server 54 and archived information maintained by the processing server 54. In step 246, the processing server 54 receives inquiries relative to the displayed content. In step 248, the processing server 54 manipulates, processes, and displays additional data in response to the received inquiries.

Although particular embodiments of the present invention have been explained in detail, it should be understood that various changes, substitutions, and alterations can be made to such embodiments without departing from the spirit and scope of the present invention as defined solely by the following claims.

What is claimed is:

1. A system for evaluating real-time current flow information, said system comprising:
a collection device operable to collect measurement data associated with at least one point in a power transmission network;
a server in communication with said collection device and operable to process said measurement data to determine a current at said at least one point; and
a client in communication with said server and operable to display said current as being associated with said at least one point and a cost associated with transmitting said current from said at least one point.

2. The system of claim 1, wherein said server includes a database having calibration data associated with said collection device, said calibration data being used by said server to process said measurement data to determine said current.

3. The system of claim 1, wherein said server includes utilization software operable when executed by said server to determine a current utilization of said power transmission network at said at least one point in response to said current and a capacity of said power transmission network at said at least one point.

4. The system of claim 1, wherein said server includes a network map including data associated with said at least one point and said current and further including data associated with other points in said power transmission network and other currents at said other points.

5. The system of claim 1, wherein said server includes path optimization software operable when executed to determine an optimal connection path in response to said current at said at least one point and current flow at other points in said power transmission network.

6. The system of claim 1, wherein said server includes a production schedule having information associated with said generation of electricity for said power transmission network.

7. The system of claim 1, wherein said server includes financial software modules operable when executed to make recommendations on transactions associated with said trading of electricity.

8. The system of claim 1, wherein said server includes financial software modules operable when executed to make financial recommendations on transactions associated with said trading of electricity.

9. The system of claim 1, and further comprising two or more sets of flow data associated with different points in said transmission network determined by said server and correlated with each other to recommend financial transactions associated with an exchange of electricity.

10. The system of claim 9, wherein said server is further operable to correlate said flow data with weather information and make recommendations related to said financial transactions in response to said correlated flow data.

11. The system of claim 9, wherein said server is further operable to correlate said flow data with source information and make recommendations related to said financial transactions in response to said correlation.

12. A method of evaluating flow rate information, said method comprising:
receiving data associated with at least one point in a network;
processing said received data to determine a flow rate at said at least one point; and
displaying said flow rate at said at least one point and a recommendation associated with said flow rate and said at least one point.

13. The system of claim 12, wherein processing said received data includes calibrating said data in response to operating conditions of said at least one point to determine said flow rate.

14. The system of claim 12, and further comprising determining a utilization of said network at said at least one point in response to said determined flow rate and a capacity of said network at said at least one point.

15. The system of claim 12, and further comprising mapping said at least one point and said flow rate onto a map of said network, said map including data associated with other points in said network and other flow rates at said other points.

16. The system of claim 12, and further comprising determining an optimal connection path on said network in response to said determined flow rate at said point and said flow rates at other points in said network.

17. The system of claim 12, and further comprising updating a production schedule associated with said network in response to said determined flow rate.

18. The system of claim 12, and further comprising forecasting future flow rates at said at least one point on network in response to empirical data associated with said at least one point and said determined flow rate.

19. The system of claim 12, and further comprising updating real-time pricing information associated with said at least one point in said network.

20. A method of evaluating real-time current flow information, said method comprising:
receiving data associated with at least one point in a power transmission network, said at least one point being located on a first connection path in said power transmission network;
processing said received data to determine a current at said at least one point in said power transmission network; and
determining an optimal connection path for transmitting electricity in response to said determined current and a cost comparison between said first connection path and a second connection path.

21. The method of claim 20, and further comprising determining a reliability rating associated with said at least one point in response to said determined current.

22. The method of claim 20, wherein determining an optimal connection path is further in response to a first reliability rating associated with said first connection path and a second reliability rating associated with said second connection path.

23. The method of claim 20, wherein determining an optimal connection path is further in response to a capacity of said first connection path.

24. The method of claim 20, wherein determining an optimal connection path is further in response to a utilization of said first connection path.

25. The method of claim 20, wherein determining an optimal connection path is further in response to empirical data associated with said at least one point.
